(19) United States
(12) Patent Application Publication
(10) Pub. No.: US 2006/0182284 A1
(43) Pub. Date: Aug. 17, 2006

(54) System and method for processing audio data for narrow geometry speakers

(75) Inventors: Mark Williams, Alberta (CA); Brian Cowieson, Alberta (CA)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: QSound Labs, Inc., Calgary (CA)

(21) Appl. No.: 11/058,669

(22) Filed: Feb. 15, 2005

(51) Int. Cl. H04R 5/00

(52) U.S. Cl. 381/17; 381/1

(57) ABSTRACT

In one representative embodiment, one or several mono audio signals and corresponding positional information are processed by respective mixing blocks. The positional information may include azimuth information, elevation information, and range information. For each mono audio signal, a plurality of left and right signals are generated using mixing techniques. The corresponding left and right signals from the plurality of mixing blocks are combined resulting in a single set of left and right signals These signals are then processed with the various placement filters and the outputs of the placement filters are combined to generate a stereo signal for output using narrow geometry speakers.

### FIELD OF THE INVENTION

The present application is generally related to processing audio data to provide a three dimensional effect.

### DESCRIPTION OF RELATED ART

A number of audio processing algorithms exist that enable a listener to perceive that an audio signal is originating from a defined location in three dimensional space using just two speakers. The first significant reproductive system was developed by Schroeder and Atal in 1963. This system relied on the concept of cross talk cancellation. Like stereo reproductive systems, three dimensional reproductive systems based on cross talk cancellation require that the listener be positioned in a “sweet spot.” This area is the apex of an equilateral triangle formed by the speakers and the listener. The speakers are therefore placed at azimuth angles of 30 degree to the listener. Since Schroeder and Atal, there have been some alternative approaches. One in particular, was that achieved by Lowe and Lees, who took a purely empirical approach and constructed transaural transfer functions, based on frequency dependant phase and amplitude shifts. This approach produced very effective and efficient transfer functions.

### SUMMARY

These technologies enable a number of useful effects. However, these technologies exhibit the desired performance only when speakers are relatively widely spaced (more than eight inches of separation). A number of devices are becoming available that do not allow multiple speakers to be sufficiently spaced. When a three dimensional positioning algorithm is incorporated within such a device, cancellation between the speakers becomes more significant due to the narrow configuration of the speakers. Accordingly, a significant amount of amplitude attenuation occurs. Additionally, a significant amount of frequency content is lost. In many cases, the audio experience is reduced to unacceptable levels by such technologies when narrow speaker geometries are employed.

Accordingly, it is an object of the present invention to provide a method and apparatus for reproducing three dimensional audio using a stereo playback system with narrowly spaced speakers.

A further object of the present invention is to provide a method and apparatus for reproducing three dimensional audio using a stereo playback system with narrowly spaced speakers in which a pre-processor is provided that accepts mono audio data and its respective positional information as inputs, processes such inputs and outputs multiple stereo streams to a filtering processor apparatus.

According to an aspect of the present invention, both processing blocks are provided for insertion between a signal source and the final power amplifier stage. The above and other objects, features, and advantages of the present invention will become apparent from the following detailed description of illustrative embodiments thereof to be read in conjunction with the accompanying drawings, in which like reference numerals represent the same or similar elements. The advantage of this approach is that the integrity of the information between the speakers is maintained.

Representative embodiments combine the benefits of the aforementioned inventions for localizing sound and for stereo enhancement thus enabling three dimensional effects to be experienced by users of devices that possess narrow geometry speaker designs (designs having speakers spaced apart by eight inches or less). In one representative embodiment, one or several mono audio signals and corresponding positional information are processed by respective mixing blocks. The positional information may include azimuth information, elevation information, and range information. For each mono audio signal, a plurality of left and right signals are generated using panning techniques. The corresponding left and right signals from the plurality of mixing blocks are summed resulting in a single set of left and right signals. The signals within this set are processed by respective placement filters. The summed outputs of these placement filters are combined to generate a stereo signal for output using narrow geometry speakers.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIG. 1 depicts a three dimensional localization block for processing mono audio information and positional information according to one representative embodiment.

FIG. 2 depicts a more detailed view of a three dimensional localization block for processing mono audio information and positional information according to one representative embodiment.

FIG. 3 depicts a more detailed view of another three dimensional localization block for processing mono audio information and positional information according to one representative embodiment.

FIG. 4 depicts an implementation of an azimuth placement filter according to one representative embodiment.

FIG. 5 depicts a flowchart according to one representative embodiment.

FIG. 6 depicts a portable device having a narrow speaker geometry and employing audio processing according to one representative embodiment.

### DETAILED DESCRIPTION

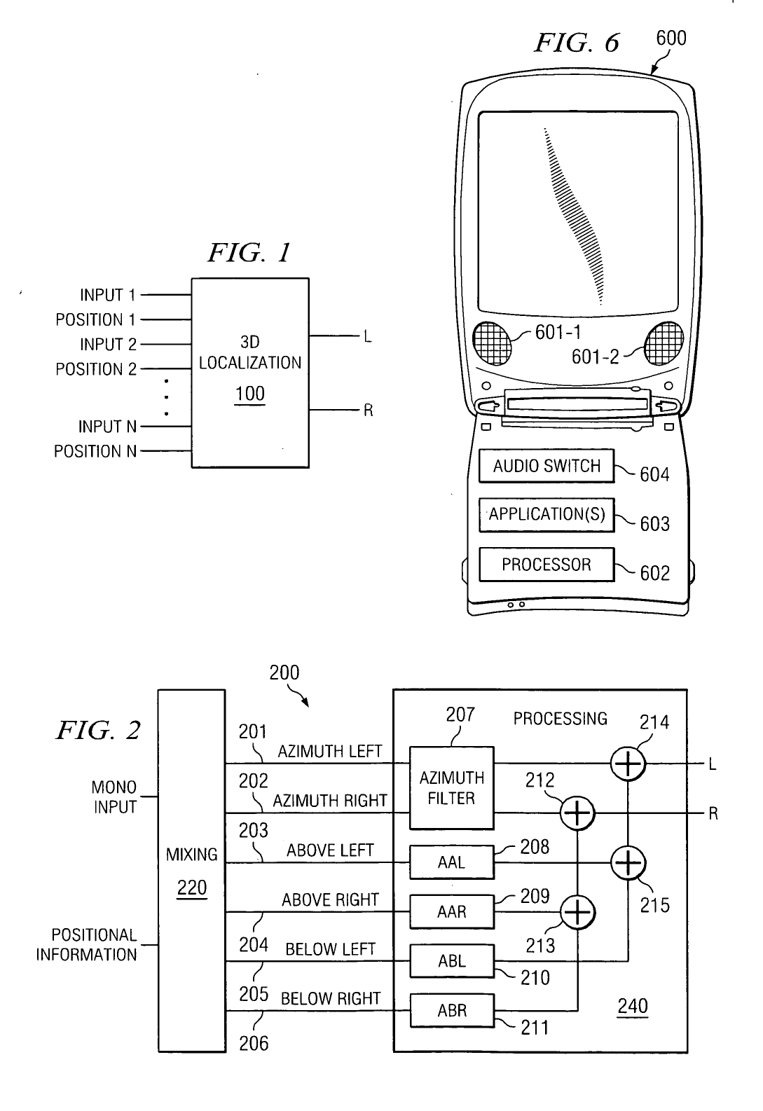

Referring to the drawings, FIG. 1 depicts three dimensional localization block 100 that provides a three dimensional effect to audio signals according to one representative embodiment. Block 100 processes one or several mono audio channels (shown as inputs 1-N) and associated positional information. The positional information may include azimuth information, elevation information, and range information. Using the positional information, the mono audio signals are preferably processed to generate azimuth left, azimuth right, above left, above right, below left, and below right signals. These signals are then processed within block 100 using placement filters to localize the audio field. Also, the azimuth filter retains center information (i.e., the placement filter retains a greater amount of energy) and is advantageous for narrow speaker geometries. The other channels are preferably processed by respective filters that “position” the signals to provide a perception of the directionality of the respective signal (e.g., below left). The outputs of the various filters are combined and outputted to left and right speakers.

FIG. 2 depicts system 200 where a single mono input signal is processed to receive a three dimensional effect according to one representative embodiment. As previously shown, the mono audio signal is received with positional information. Using the positional information, mixing block 220 processes the mono input audio signal using panning techniques to generate respective signals intended for left and right speakers. For example, if the positional information indicates that a sound originated from the extreme right of the listener, a respective “right” signal would be generated to possess substantially greater amplitude that the respective “left” signal. If the positional information indicates that a sound originated from immediately in front of the listener, the respective right and left signals would possess approximately equal amplitude. For positions between the two extremes, various amplitude ratios may be employed according to known panning algorithms.

Separate processing preferably is applied for azimuth and elevation information whereas ranging position is implemented through volume scaling in the mixer. The generated signals may include azimuth left signal 201, azimuth right signal 202, above left signal 203, above right signal 204, below left signal 205, and below right signal 206. Azimuth left signal 201 and azimuth right signal 202 are preferably generated using azimuth information. Above left signal 203 and above right signal 204 are preferably generated in response to elevation information. Likewise, below left signal 205 and below right signal 206 are similarly generated. Range information may be used to selectively scale the various signals.

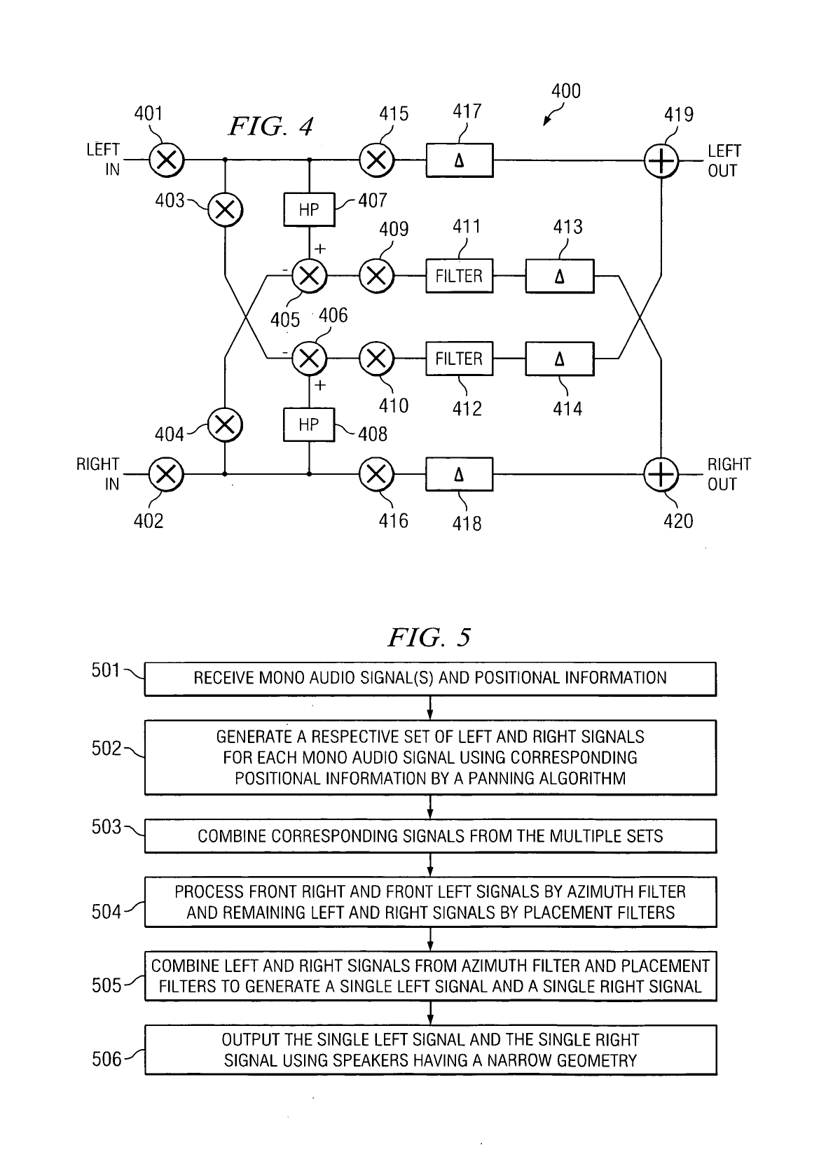

Each left and right signal is then provided to filter processing block 240. Within filter processing block 240, filter 207 processes azimuth signal 201 and azimuth signal 202. Filter 207 may be implemented using the design shown in FIG. 4. Azimuth filter 207 removes a portion of the audio information (“center” information) that is common or substantially common to both the left and right signals before processing the signal in left and right sound placement filters. The outputs of the processing block 207 provide azimuth positioning. Placement filters 208-211 process the remaining signals. Filters 208-211 may be implemented using finite impulse response (FIR) designs with delay, infinite impulse response (IIR) responses, and other suitable designs. The respective right signals are combined using adders 212 and 213. The respective left signals are combined using adders 214 and 215.

The combined signals are then provided to left and right speakers (not shown) and the listener experiences a three dimensional effect in the audio experience. Additionally, because the placement filter retains center information, relatively little amplitude attenuation occurs. Accordingly, the output signals of system 100 may be provided to speakers having narrow speaker geometries.

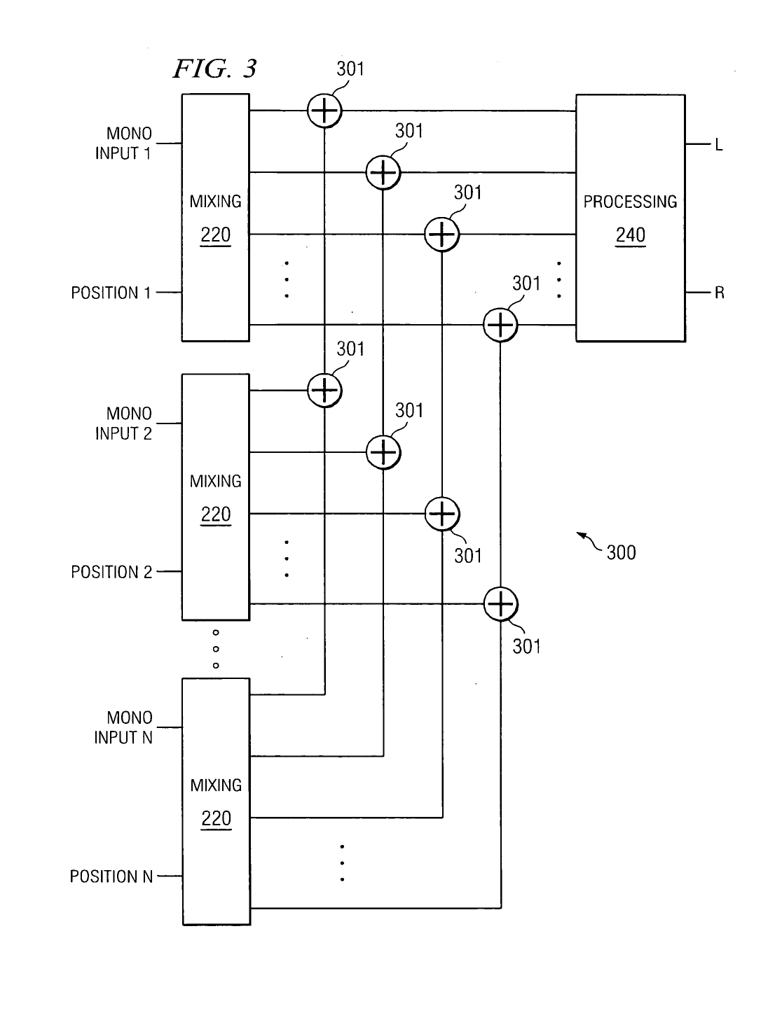

FIG. 3 depicts system 300 where multiple mono input signals are processed to receive a three dimensional effect according to one representative embodiment. System 300 operates in a manner that is substantially similar to the operations of system 200. Each mono input signal with positional information is provided to a respective mixing block 220 that processes the signals using panning techniques. In one preferred embodiment, the corresponding signals from mixing blocks 220 are then combined in a cascaded manner using adders 301. After all of the corresponding signals have been combined, a single filter processing block 240 filters the signals and outputs a left and right signal for provision to speakers.

FIG. 4 depicts an implementation of placement filter 400 according to one representative embodiment. Left and right signals are received and scaled by elements 401 and 402. The left scaled signal is then provided to multiplier 403 and highpass filter 407. Similarly, the right scaled signal is provided to multiplier 404 and highpass filter 408. Element 405 subtracts the signal from multiplier 404 from the signal from highpass filter 407. Likewise, element 406 subtracts the signal from multiplier 403 from the signal from highpass filter 408. Thereby, the information that is substantially common to the right and left channels is removed. The respective difference signals are respectively processed by multipliers 409 and 410, placement filters 411 and 412, and delay elements 413 and 414.

Referring again to the scaled versions of the original left and right channels, further scaling is preferably performed by multipliers 415 and 416 and delay is provided by delay elements 417 and 418. The outputs of delay elements 417 and 418 are respectively combined using adders 419 and 420. At this point, the center information is added to the signals generated by placement filters 411 and 412. Specifically, the outputs of adders 419 and 420 are signals that possess azimuth information while retaining center information.

Additional details regarding the implementation of this placement processing may be found in U.S. Pat. No. 5,440,638 which is incorporated herein by reference.

FIG. 5 depicts a flowchart according to one representative embodiment. In step 501, one or several mono audio signals are received with corresponding positional information. In step 502, each of the mono audio signals is processed to generate a plurality of signals using panning techniques. In step 503, selected ones of the corresponding signals are combined (if multiple mono audio signals are received). In step 504, the signals are processed using an azimuth filter and a plurality of placement filters. In step 505, the outputs of the azimuth filter and the placement filters are combined to generate a single right signal and a single left signal. In step 506, the single right signal and single left signal are provided to speakers having a narrow speaker geometry.

FIG. 6 depicts portable device 600 (e.g., a cellular phone) including entertainment functionality suitable for use in conjunction with some representative embodiments. Device 600 includes speakers 601-1 and 601-2 that are relatively closely spaced (e.g., within eight inches or approximately within 20 cms). Accordingly, the use of existing technologies by device 600 would result in an unacceptable audio experience. Accordingly, device 600 provides a three dimensional effect to audio signals using the processing previously described herein.

In one representative embodiment, the three dimensional effect processing is achieved using processor 602 and audio software 604. When a user selects a respective application 603 (e.g., a video game), the application 603 may provide one or several mono audio signals to audio software 604 with positional information, audio software 604 provides a three dimensional effect to each mono audio signal by processing with respective mixing blocks, combining corresponding signals from the mixing blocks, and filtering the corresponding signals. Although software is used in one representative embodiment, integrated circuitry may be used in lieu thereof and in addition if desired.

Due to the combination of processing, the listener experiences a degree of directionality in the listening experience. Moreover, the center information is retained and the amplitude of the stereo signals having the three dimensional effects is maintained and low frequency content is retained. Accordingly, the listening experience is maintained at a relatively high level even when narrow speaker geometries are employed. Additionally, the complexity of the audio processing is maintained at reasonable levels for multiple audio signals and, hence, the processing is suitable for a wide range of devices and applications.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method comprising:
receiving a mono audio signal and positional information;
generating a plurality of signals from said mono audio signal using said positional information according to a panning algorithm;
processing a left signal and a right signal of said plurality of signals by an azimuth filter, wherein said azimuth filter removes audio information that is substantially common to said left signal and right signal before filtering by left and right placement filters and combines outputs of said left and right placement filters with said removed audio information;
processing remaining signals of said plurality of signals using respective placement filters;
combining signals generated by said processing a left signal and a right signal and signals generated by processing said remaining signals to produce a stereo signal; and
providing said stereo signal for output using two speakers having a narrow geometry.

2. The method of claim 1 wherein said generating a plurality of signals generates an azimuth left signal, an azimuth right signal, a below left signal, a below right signal, an above left signal, and an above right signal.

3. The method of claim 1 wherein said positional information includes azimuth information and elevation information.

4. The method of claim 3 wherein said positional information further includes range information.

5. The method of claim 1 wherein said two speakers are integrated in a handheld device.

6. A system comprising:
a mixing block for receiving a mono audio signal and positional information, wherein said mixing block is operable to generate a plurality of left and right signals using said positional information according to a panning algorithm;
a filter block for filtering said plurality of left and right signals from said mixing block, wherein said filter block comprises (i) an azimuth filter that removes audio information that is substantially common to said left signal and right signal before filtering by left and right placement filters and combines outputs of said left and right placement filters with said removed audio information, (ii) said filter block further comprises a plurality of placement filters for filtering remaining signals of said plurality of left and right signals, and (iii) a plurality of adders for combing left and right signals from said expanding filter and said placement filters; and
speakers having a narrow geometry for rendering output signals from said filter block.

7. The system of claim 6 wherein said system comprises a plurality of mixing blocks and a plurality of adders for combining corresponding signals from said plurality of mixing blocks before filtering by said filter block.

8. The method of claim 6 wherein said mixing block generates an azimuth left signal, an azimuth right signal, a below left signal, a below right signal, an above left signal, and an above right signal.

9. The method of claim 6 wherein said positional information includes azimuth information and elevation information.

10. The method of claim 9 wherein said positional information further includes range information.

11. The method of claim 6 wherein said system is a handheld device.

12. A method comprising:
receiving a plurality of mono audio signals and associated positional information;
generating a respective set of signals from each of said plurality of mono audio signals using said associated positional information according to a panning algorithm;
combining azimuth left signals and azimuth right signals from each of said sets;
combining above left signals and above right signals from each of said sets;
combining below left signals and below right signals from each of said sets;
processing said combined azimuth left signal and combined right signal by an azimuth filter, wherein said azimuth filter removes audio information that is substantially common to said combined azimuth left signal and said combined azimuth right signal before filtering by placement filters, and combines outputs of said placement filters with said removed audio information;
processing said combined above left signal, said combined above right signal, said combined below left signal, and said combined right signal by respective placement filters;
combining each of said processed left signals and each of said processed right signals; and
outputting said combined processed left signal and said combined processed right signal using speakers having a narrow geometry.

13. The method of claim 12 wherein said positional information includes azimuth information and elevation information.

14. The method of claim 13 wherein said positional information further includes range information.

15. The method of claim 12 wherein said speakers are integrated in a handheld device.
